(19) United States
(12) Patent Application Publication
(10) Pub. No.: US 2007/0098324 A1
(43) Pub. Date: May 3, 2007

(54) Optical multiplexer and projection type display device incorporating same

(75) Inventors: Atsushi Kitamura, Kitasaku-gun (JP); Sawa Tanabe, Kitasaku-gun (JP)

Correspondence Address: OLIFF & BERRIDGE, PLC, P.O. BOX 19928, ALEXANDRIA, VA, 22320, US

(73) Assignee: MINEBEA CO., LTD, KITASAKU-GUN (JP)

(21) Appl. No.: 11/542,203

(22) Filed: Oct. 4, 2006

(30) Foreign Application Priority Data
Oct. 31, 2005 (JP) 2005-316951

(51) Int. Cl. G02B 6/28; G02B 6/34

(52) U.S. Cl. 385/37; 385/24

(57) ABSTRACT

There is provided an optical multiplexer which includes a plurality of light sources to emit light beams having respective different wavelengths, and a diffraction grating to reflect the light beams emitted from the light sources. The plurality of light sources are positioned and oriented with respect to one another and to the diffraction grating so that the light beams which are emitted from the light sources, fall on the diffraction grating, and are reflected thereat are mixed so as to proceed along one common optical path. This enables downsizing of a device and ensures a reliable multiplexing of light beams with a simple optical system.

### BACKGROUND OF THE INVENTION

1. Field of the Invention

The present invention relates to an optical multiplexer, and more particularly to an optical multiplexer which uses a diffraction grating to multiplex a plurality of light beams having respective different wavelengths, and further relates to and a projection type display device incorporating the same.

2. Description of the Related Art

A small-size projection type display device tends to incorporate a high-output light emitting diode (LED) or laser diode (LD) in order to cope with the constraints resulting from the overall dimension, color rendition, heat radiation, reliability, cost, and the like. And, in particular, small projectors using a plurality of light sources to respectively emit light beams having different wavelengths are rapidly coming into the market. The light beams often are composed of three (RGB) colors, specifically, red (R), green (G), and blue (B) colors, and are multiplexed into one light beam taking one same optical path by means of an optical engine in a projector, and the one light beam thus multiplexed passes through or reflects at a display device, such as a light-transmissive liquid crystal display (LCD), a digital micro-mirror device, and the like, and then is projected by a projection lens onto a screen. RGB-LEDs or RGB-LDs, in place of short-life discharge lamps, are considered for use as light sources in a latest micro-display rear projection TV, thus increasingly providing various applications in projection type display devices.

In a conventional optical multiplexer disclosed in, for example, Japanese Patent Application Laid-Open No. 2003-121923, components such as a dichroic filter and a polarizing beam splitter are used to multiplex a plurality of light beams having respective different wavelengths. Those components, however, have to use a costly dielectric multilayer. Also, when a cross-cube prism with a dichroic filter is used, geometrical error factors are often caused at the center portion resulting in distorting or adversely affecting a transmitted light. Further, use of a polarizing beam splitter can handle only up to two light beams at one time, and other means, for example a dichroic filter, must be used in combination in order to multiplex three light beams like RGB colors into one same optical path, which inevitably makes the structure complex causing a cost increase. LED light used in the above-described device is a non-polarized light, and when applied to a polarizing beam splitter, the light amount is decreased by half at a single transmission or reflection.

In another optical multiplexer disclosed in, for example, Japanese Patent Application Laid-Open No. 2002-250893, the optical paths are multiplexed by means of the refractive angle of a prism. In this case, however, the prism configuration is complicated making the manufacturing method difficult. Also, when the optical multiplexing/demultiplexing operation is duly performed using the prism, the optic angle with respect to the prism plane tends to be small, which makes the optical axis alignment difficult. And, in the multiplexing method using the refractive angle of the prism, since the color reproducibility is governed by the spectral characteristics of the RGB-LEDs, the color rendering property is deteriorated when LEDs with a large half-value width are used.

### SUMMARY OF THE INVENTION

The present invention has been made in light of the above problems, and it is an object of the present invention to provide an optical multiplexer which can be downsized, and which enables reliable multiplexing of light beams by a simple optical system, and also to provide a projection type display device incorporating such an optical multiplexer.

In order to achieve the object described above, according a first aspect of the present invention, an optical multiplexer includes a plurality of light sources to emit light beams having respective different wavelengths, and a diffraction grating to reflect the light beams emitted from the light sources. In the optical multiplexer, the plurality of light sources are positioned and oriented with respect to one another and to the diffraction grating so that the light beams emitted from the light sources, falling on the diffraction grating, and reflected thereat are mixed so as to proceed along one common optical path.

In the first aspect of the present invention, the plurality of light sources may be positioned and oriented so that in case where a light beam emitted from a light source and having a wavelength λ falls incident on a groove of the diffraction grating at an angle α defined with respect to a normal line to the diffraction grating and is reflected from the groove at an angle β defined with respect to the normal line, a grating equation of “d(sinα±sinβ)=nλ” or “sinα±sinβ=Nnλ”, where parameters are defined as: d=grating spacing; N=number of grooves per mm=1/d; and n=diffraction order, is satisfied by appropriately determining the parameters so that the light beams from the light sources are reflected by the diffraction grating at the angle β so as to proceed along one common optical path.

In the first aspect of the present invention, the diffraction grating may have either a flat major surface or a concave major surface, and the plurality of light sources may be each constituted by either a light emitting diode or a laser diode and may emit red, green and blue light beams, respectively.

According to a second aspect of the present invention, a projection type display device includes: an optical multiplexer structured as described in the first aspect of the present invention; and a projection optical system including a condenser lens, an optical integrator rod, and a projector lens, which are all disposed on a common optical axis. The light sources of the optical multiplexer may emit red, green and blue light beams, respectively.

Since the optical multiplexer according to the present invention is essentially composed of a plurality of light sources and a diffraction grating without using expensive dichroic filter or light beam splitter, the assembly work is eased, and the structure is simplified thus reducing the dimension and also cost of the device. Also, the light sources can be duly and easily positioned and oriented with respect to one another and to the diffraction grating by setting the parameters such as the incidence angle α, the diffraction (reflection) angle β, the respective wavelengths λ_{R}, λ_{G} and λ_{B}, the number of grooves N at the diffraction grating, and the number of diffraction n. And, the light sources can be provided with a high color reproducibility by arbitrarily changing the spectral characteristic of a diffracted light. Consequently, the projection type display device according to the present invention, which incorporates the above-described optical multiplexer, enjoys the advantages that the optical multiplexer provides.

### BRIEF DESCRIPTION OF THE DRAWINGS

FIG. 1 is a schematic side view of an optical multiplexer according to a first embodiment of the present invention;

FIG. 2 is a schematic side view of an optical multiplexer according to a second embodiment of the present invention;

FIGS. 3A and 3B show expressions about relation between an incidence angle and a diffraction angle at a diffraction grating incorporated in the present invention, accompanied by schematic side views to explain the relational expressions, wherein FIG. 3A is a general expression and FIG. 3B concerns a case where three light beams are multiplexed into one optical path;

FIG. 4 is a graph showing a diffraction angle as a function of a wavelength for a light beam falling incident on the diffraction grating at an angle of 45 degrees for three cases defined by different groove densities on the diffraction grating;

FIG. 5 is a graph showing diffraction angle as a function of incidence angle in case of a groove density of 600/mm on the diffraction grating;

FIG. 6 is a table showing incidence angles θ_{R}, θ_{G} and θ_{B} for each diffraction angle θᵢ in the optical multiplexer according to the present invention;

FIG. 7 is a perspective view of a projection type display device according to a third embodiment of the present invention;

FIG. 8 is a graph showing a luminescence spectrum of an LED; and

FIG. 9 is a graph showing an example of comparison of a color reproduction range between an LED backlight and other color spaces.

### DETAILED DESCRIPTION OF THE INVENTION

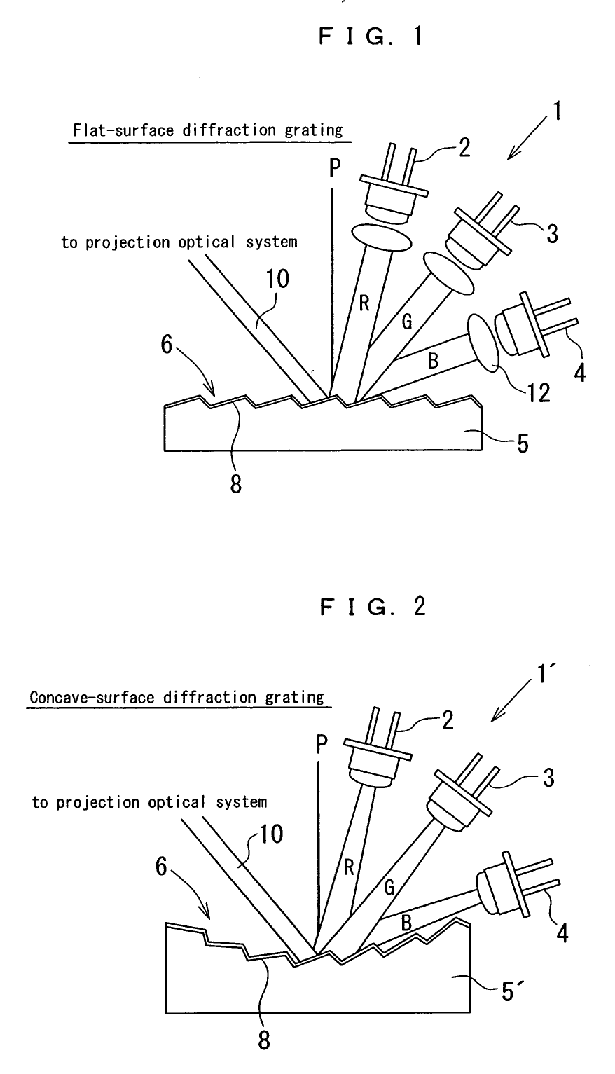

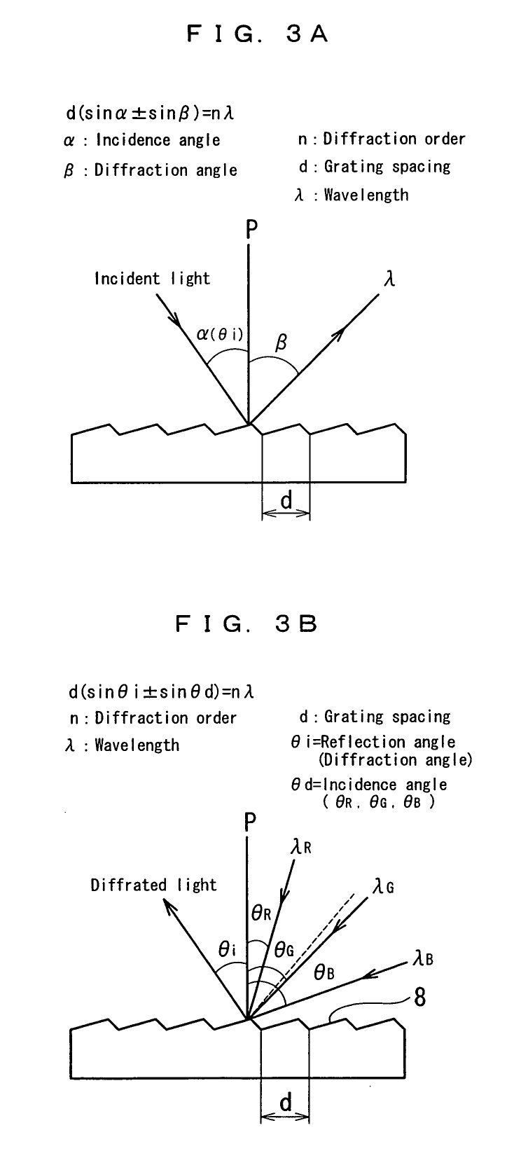

Preferred embodiments of the present invention will be described with reference to the accompanying drawings. FIGS. 1 and 2 represent fundamental structures of optical multiplexers according to the present invention, respectively showing a first embodiment using a flat-surface diffraction grating, and a second embodiment using a concave-surface diffraction grating. Referring to FIGS. 1 and 2, in which corresponding component parts are denoted by the same reference numerals, an optical multiplexer 1/1′ according to the first/second embodiment includes three light sources 2, 3 and 4 adapted to emit red (R), green (G), and blue (B) light beams, respectively, and a flat-surface/concave-surface blazed diffraction grating 5/5′. The diffraction grating 5/5′ is made of a metal plate typically mirror-finished, and has on its major surface (flat/concave) a plurality of grooves 6 formed in parallel to one another with a density of 300 to several thousand per mm, wherein lights reflected from the surface of the diffraction grating 5/5′ are adapted to interfere with one another. By appropriately selecting an incidence angle α and a diffraction (reflection) angle β (refer to FIG. 3A) with respect to the diffraction grating 5/5′, a light having a particular wavelength can be picked out.

The light sources 2, 3 and 4 for R, G and B light beams are disposed such that the R, G and B light beams fall incident on the diffraction grating 5/5′ at respective predetermined angles with respect to a normal line P to the diffraction grating 5/5′, and that the R, G and B light beams are diffracted (reflected) at reflection surfaces constituted by inclined faces 8 of the grooves 6 so as to proceed along a common optical path 10. The light sources 2, 3 and 4 are constituted by LEDs or LDs to emit R, G and B light beams, respectively, for the purpose of downsizing, reliability, and the like.

Referring to FIG. 1, the optical multiplexer 1 according to the first embodiment further includes a coupling lens 12 disposed at each of the light sources 2, 3 and 4, and the R, G and B light beams from the light sources 2, 3 and 4 are collimated by respective coupling lenses 12 and fall incident on the flat-surface diffraction grating 5 at angles θ_{R}, θ_{G} and θ_{B}, respectively, with respect to the normal line P to the diffraction grating 5 (see FIG. 3B). On the other hand, the diffraction grating 5′ of the optical multiplexer 1′ according to the second embodiment shown in FIG. 2 has its grating surface concavely curved so as to function like a collimator lens in addition to a diffraction grating, which eliminates the need of providing coupling lenses thus allowing the R, G and B light beams from the light sources 2, 3 and 4 to directly fall incident on the diffraction grating 5′.

The R, G and B light beams have respective wavelengths λ_{R}, λ_{G} and λ_{B}: for example, λ_{R}=638 nm, λ_{G}=545 nm, and λ_{B}=453 nm. In the embodiments described herein, red, green and blue light beams are used, but the present invention is not limited to this light beam arrangement, and light beams of other wavelengths (colors) may be used. Also, the number of light sources is not limited to three but may alternatively be two, four, or more.

The diffraction grating 5/5′ of the optical multiplexer 1/1′ may have, on its surface, grooves each having a rectangular, sinusoidal, or triangular configuration in its cross section, and preferably is a blazed diffraction grating which has, on its flat or concaved mirror surface, grooves each having a triangular cross section so as to form a serrated profile as a whole. Such a diffraction grating is fabricated such that grooves producing a serrated profile are formed on a surface of a blank plate made of resin, soda glass, and the like, and the surface profiled with serration is coated with aluminum by vacuum evaporation.

The grooves 6 producing a serrated profile are processed with optical precision, for example, by the holographic exposure method based on the two-beam interference technique using laser. Since the blazed diffraction grating has an asymmetric profile pattern, diffracted lights can be converged on a given order thus effectively utilizing lights and significantly reducing stray lights related to the periodic error of the grooves 6. Also, since the grooves 6 are blazed by the ion beam etching method, a blazed grating with various blaze angles can be produced.

Unlike the diffraction grating 5 of the first embodiment shown in FIG. 1, in the diffraction grating 5′ of the second embodiment shown in FIG. 2, the grooves 6 constituting a serrated profile are formed on a concave grating surface which functions as a collimating means, and therefore the need for providing the coupling lenses 12 is eliminated thus allowing the R, G and B light beams from the light sources 2, 3 and 4 to impinge directly on the inclined faces 8 of the grooves 6.

Referring to FIG. 3A showing a blazed diffraction grating (the flat-surface diffraction grating 5 is taken as an example), when a light beam emitted from a light source falls incident on the inclined face (8) of the groove (6) at an angle a (an angle formed by the incident light beam with respect to the normal line P), a light beam having a wavelength λ is reflected from the inclined face (8) at an angle β. The relation between the incidence angle a and the reflection (diffraction) angle β is to satisfy the following grating equation:
d(sinα±sinβ)=nλ (1) or
sinα±sinβ=Nnλ (2)
where: d is the grating spacing; N is the number of grooves per mm=1/d; n is the diffraction order; and λ is the wavelength.

The above equation is a general expression applied in the case where a single white light beam impinges on the diffraction grating (5) at an incidence angle a (θᵢ) and is split into three primary colors in such a manner that red (R), green (G) and blue (B) light beams having different wavelengths λ(λ_{R}, λ_{G} and λ_{B}) are reflected at respective diffraction angles β (θ_{R}, θ_{G} and θ_{B}).

On the other hand, the present invention does not pertain to the case that a single white light beam is split into three primary colors as shown in FIG. 3A, but to the case that three different light beams emitted respectively from three light sources fall incident on the diffraction grating (5) and are reflected therefrom so as to proceed along a common optical path as shown in FIG. 3B. There is a reversible relation between the incident light and the reflected light, and therefore the principle holds true if the incident light and the reflected light are interchanged with each other.

In the present invention, the light beam incident on the diffraction grating and the light beam reflected from the diffraction grating are positioned oppositely to those shown in FIG. 3A, and three light beams having respective different wavelengths λ_{R}, λ_{G} and λ_{B} are incident on the diffraction grating 5 at respective angles θ_{R}, θ_{G} and θ_{B}. Accordingly, in the actual practice of the present invention, the aforementioned incidence angle α corresponds to a diffraction angle θᵢ, and the respective diffractions angles β correspond to incidence angles θ_{R}, θ_{G} and θ_{B}. The incidence angles θ_{R}, θ_{G} and θ_{B} of the three light beams can be determined by setting the parameters d, N, n, λ and θᵢ of the grating equation described above.

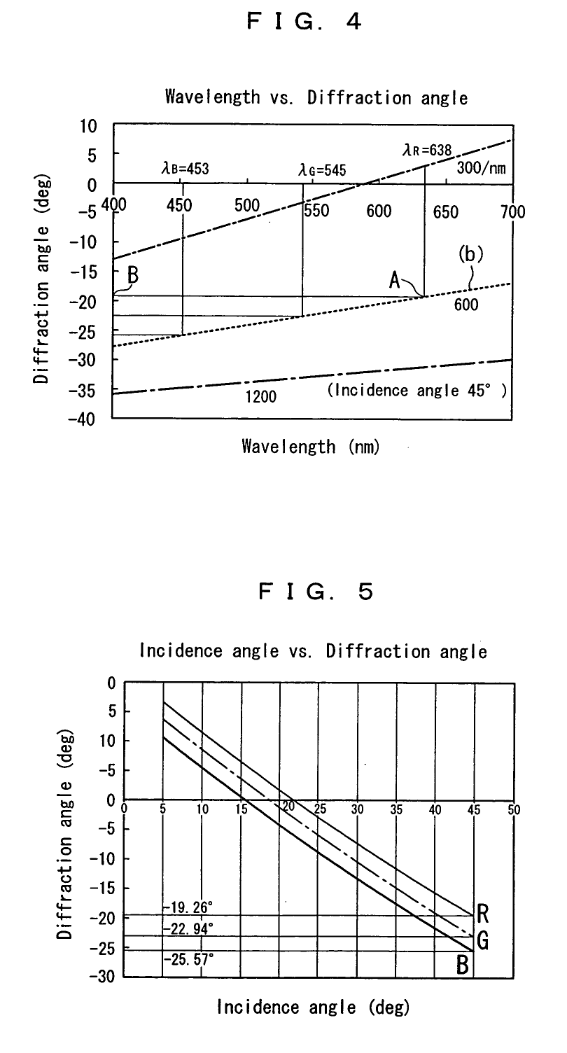

FIGS. 4 and 5 are graphs about the relation expressed by the above equation. Specifically, FIG. 4 shows the relation of a diffraction angle varying as a function of a wavelength for a light beam impinging on a diffraction grating at an incidence angle θᵢ of 45 degrees, wherein the three characteristic lines pertain to respective cases where the light beam impinges on three diffraction gratings with different groove densities of 300/mm, 600/mm and 1200/mm, and FIG. 5 shows the relation of a diffraction angle varying as a function of an incidence angle for three (R, G and B) light beams impinging on a diffraction grating with a groove density of 600/mm, wherein the characteristic lines are for finding incidence angles θ_{R}, θ_{G} and θ_{B} of the light R, G and B beams which make it happen that the R, G and B light beams are reflected from the diffraction grating at a diffraction angle (angle θᵢ formed between the diffracted light and the normal line to the diffraction grating) so as to proceed as one light beam.

Now, description will be made on how the light beam sources 2, 3 and 4 (R, G and B) in the structures of FIGS. 1 and 2 are positioned using the above grating equation and the graphs of FIGS. 4 and 5 derived from the grating equation. The following is a method of finding requisite incidence angles θ_{R}, θ_{G} and θ_{B} at the diffraction grating 5.

### EXAMPLE

For convenience sake, the values of the above-described parameters are determined as follows: the incidence angle α=45 degrees; the number of grooves N=600/mm; the diffraction order n=1; the wavelength of a red light beam λ_{R}=638 nm; the wavelength of a green light beam λ_{G}=545 nm; and the wavelength of a blue light beam λ_{B}=453 nm.

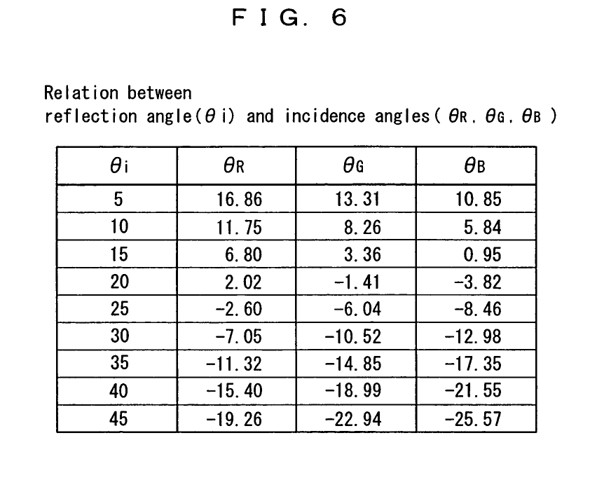

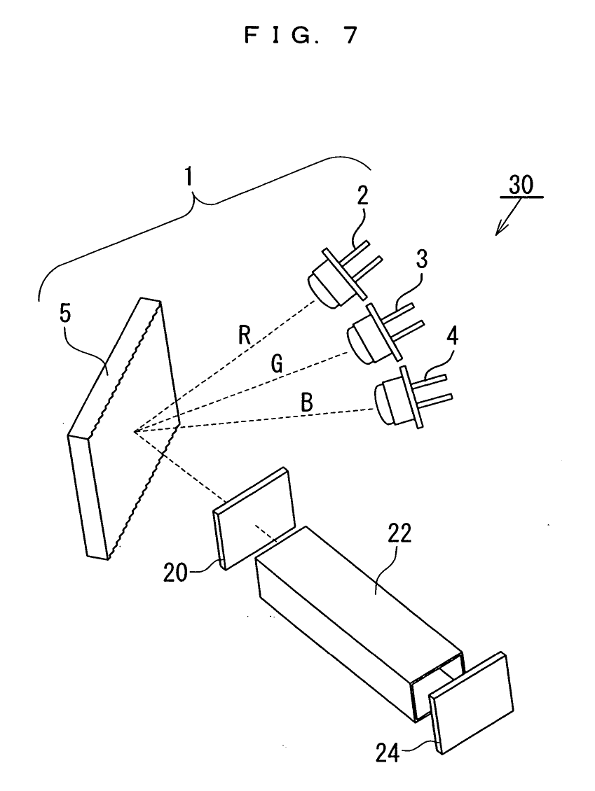

When it is assumed that the diffraction angle θᵢ of the multiplexed light beam is 45 degrees at N=600/mm, the horizontal line, which is drawn from a intersection point A of the characteristic line (b) of FIG. 4 with the vertical line drawn from the wavelength λ_{R}638 nm, makes with the vertical axis an intersection point B reading a diffraction angle of 19.26 degrees, which is translated as an incidence angle θ_{R} of 19.26 degrees for the R light beam. In the same way, the incidence angles θ_{G} and θ_{B} of the G and B light beams are found to be 22.94 degrees and 25.57 degrees, respectively. Also, the incidence angles θ_{R}, θ_{G} and θ_{B} of the R, G and B light beams are found similarly from the characteristic lines of FIG. 5 to be 19.26 degrees, 22.94 degrees, and 25.57 degrees, respectively. Values gained from the graph of FIG. 4 or FIG. 5 are shown in the table of FIG. 6.

As is clear from the above description, the incidence angles θ_{R}, θ_{G} and θ_{B} of the R, G and B light beams having respective wavelengths λ_{R}, λ_{G} and λ_{B} can be determined by the values gained by calculation according to the above grating equation. And, if the light sources 2, 3 and 4 for the R, G and B light beams are located so as to satisfy a relation defined by the values gained, then the R, G and B light beams emitted from the light sources 2, 3 and 4 are adapted to reflect from the diffraction grating so as to proceed along one common optical path. Thus, in the optical multiplexer 1/1′, the light sources 2, 3 and 4 for the R, G and B light beams can be duly arranged according to respective incidence angles θ_{R}, θ_{G} and θ_{B} obtained in the above Example so that the R, G and B light beams reflect from the diffraction grating 5/5′ to proceed along the common optical path 10. As well known, the above-described optical multiplexer 1/1′ can be used for a rear or front projection system with LCD.

Description will now be made on a projection type display device according to the present invention. Referring to FIG. 7, a projection type display device 30 incorporates an optical multiplexer according to the present invention, specifically the projection type display device 30 includes: an optical multiplexer 1 which includes three light sources 2, 3 and 4, and a diffraction grating 5 (coupling lens are omitted for simplicity); and a projection optical system which includes a condenser lens 20, an optical integrator rod 22, and a projector lens 24. In the projection type display device 30, R, G and B light beams emitted from the light sources 2, 3 and 4 fall incident on the diffraction grating 5, and are reflected therefrom so as to proceed as one multiplexed light beam along a common optical path, and the multiplexed light beam thus generated is condensed by the condenser lens 20, has its light intensity uniformized while progressing through the optical integrator rod 22, goes through image information of a display device (not shown in the figure) such as DMD and LCD, and then is projected onto a screen by the projector lens 24.

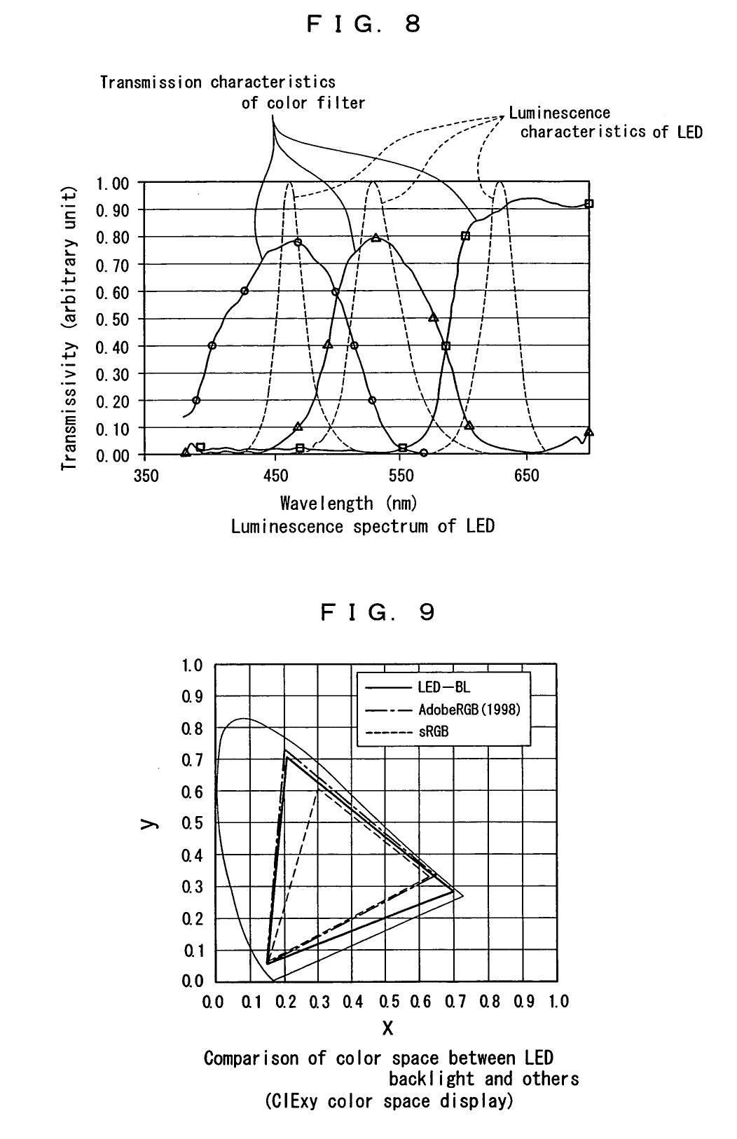

Referring to FIG. 8, when the optical multiplexer 1/1′ according to the present invention uses high-output LEDs as light sources, the sub-peaks of primary colors are eliminated, which results in an improved primary color purity consequently increasing the color reproduction range. And, referring to FIG. 9, the LED backlight (LED-BL) has a larger color space than the Adobe RGB and the s RGB (for CRT color reproduction range), and it is obviously advantageous to use an LED as a light source.

In the optical multiplexer 1/1′, optical paths are multiplexed as follows: the light sources 2, 3 and 4 for the R, G and B light beams of respective different wavelengths are appropriately positioned and oriented so that the R, G and B light beams fall incident on the blazed diffraction grating 5/5′ at respective predetermined angles and are reflected at the grooves 6 of the diffraction grating 5/5′ so as to be mixed into one light beam to proceed along the common optical path 10. Then, the one light beam thus formed is emitted toward the projection optical system. The respective angles (θ_{R}, θ_{G} and θ_{B}) are determined by setting the parameters based on the grating equation (1) or (2) described above.

Thus, when the light sources 2, 3 and 4 to emit the R, G and B light beams having respective different wavelengths are arranged with appropriate position and orientation, the R, G and B light beams emitted from the light sources 2, 3 and 4 and falling incident on the blazed diffraction grating 5/5′ are adapted to reflect at the grooves 6 of the diffraction grating 5/5′ so as to be mixed into one light beam to proceed along the common optical path 10 as shown in FIG. 1/2, and the one light beam thus formed is emitted toward the projection optical system where, as shown in FIG. 7, the one light beam passes through the condenser lens 20 and the optical integrator rod 22, is converted into image information at the display device (not shown) disposed on the same optical axis as the condenser lens 20 and the optical integrator rod 22, and is then projected onto a screen by the projector lens 24.

In a conventional projection type display device, light beams emitted from R, G and B light sources are condensed by a color composing means including two dichroic mirrors whose angles are adjusted so as to reflect the R, G and B light beams toward a micro-lens array at respective dispersion angles, and an image which is formed such that R, G and B components emitted from the micro-lens array pass respective R, G and B pixel portions of a liquid crystal panel and are thereby modulated is magnified and projected onto a screen by a projector lens. Such a conventional projection type display device incurs the problems described in the Related Art. On the other hand, since the present invention utilizes diffraction principle to multiplex the R, G and B light beams, a reliable multiplexing performance can be achieved by a simple optical system. Also, since incidence and diffraction angles with respect to the diffraction grating 5/5′ can be optionally set by arbitrarily determining the grating spacing d and the diffraction order n of the diffraction grating, a greater degree of design freedom is afforded thus proving to be favorable to downsizing of the device. And, the diffraction grating 5/5′ has periodic grooves 6 formed on its flat/concave surface, which simplifies the manufacturing method as compared with prisms thus achieving the cost reduction.

The spectral characteristic of diffracted light, which generally depends on light beams and the number N of effective grooves formed on a diffraction grating, can be optionally determined by adjusting the number of grooves and the diameter of light beams. A diffraction grating with a larger number of effective grooves is adapted to provide a higher wavelength selectivity, which narrows the spectral characteristic of diffracted light. Thus, light sources provided with a high color reproducibility can be achieved by modulation of the spectral characteristic of diffracted light, where the modulation is performed by adjusting the diameters of the light beams from the light sources by means of the lens system, and/or by changing the grating spacing d at the diffraction grating.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An optical multiplexer comprising:
a plurality of light sources to emit light beams having respective different wavelengths; and
a diffraction grating to reflect the light beams emitted from the light sources, wherein the plurality of light sources are positioned and oriented with respect to one another and to the diffraction grating such that the light beams emitted from the light sources, falling on the diffraction grating, and reflected thereat are mixed so as to proceed along one common optical path.

2. An optical multiplexer according to claim 1, wherein the plurality of light sources are positioned and oriented such that in case where a light beam emitted from a light source and having a wavelength λ falls incident on a groove of the diffraction grating at an angle α defined with respect to a normal line to the diffraction grating and is reflected from the groove at an angle β defined with respect to the normal line, a grating equation of “d(sinα±sinβ)=nλ” or “sinα±sinβ=Nnλ” where parameters are defined as: d=grating spacing; N=number of grooves per mm=1/d; and n=diffraction order, is satisfied by appropriately determining the parameters so that the light beams from the light sources are reflected by the diffraction grating at the angle β so as to proceed along one common optical path.

3. An optical multiplexer according to claim 1, wherein the diffraction grating has one of a flat major surface and a concave major surface.

4. An optical multiplexer according to claim 1, wherein the plurality of light sources are each constituted by one of a light emitting diode and a laser diode.

5. An optical multiplexer according to claim 1, wherein the plurality of light sources emit red, green and blue light beams, respectively.

6. A projection type display device comprising:
an optical multiplexer comprising a plurality of light sources to emit light beams having respective different wavelengths, and a diffraction grating to reflect the light beams emitted from the light sources, wherein the plurality of light sources are positioned and oriented with respect to one another and to the diffraction grating such that the light beams emitted from the light sources, falling on the diffraction grating, and reflected thereat are mixed so as to proceed along one common optical path; and
a projection optical system comprising a condenser lens, an optical integrator rod, and a projector lens, wherein the condenser lens, the optical integrator rod, and the projector lens are disposed on a common optical axis.

7. A projection type display device according to claim 6, wherein the plurality of light sources emit red, green and blue light beams, respectively.
